(19) United States
(12) Patent Application Publication
(10) Pub. No.: US 2011/0010696 A1
(43) Pub. Date: Jan. 13, 2011

(54) DUPLICATE VIRTUAL FUNCTION TABLE REMOVAL

(75) Inventors: Sheldon M. Lobo, Cary, NC (US); Fu-Hwa Wang, Saratoga, CA (US)

Correspondence Address: OSHA LIANG LLP/Oracle, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 12/500,282

(22) Filed: Jul. 9, 2009

(51) Int. Cl. G06F 9/45; G06F 9/44

(52) U.S. Cl. 717/151; 717/165; 717/116

(57) ABSTRACT

One or more embodiments of the present invention relate to a method for duplicate virtual function table removal. The method includes identifying, using a processor of a computer, a first virtual function table formed when a first source code is compiled into a first object code. The method further includes using the processor, identifying a second virtual function table formed when a second source code is compiled into a second object code. The method further includes, independent of linking the first object code to a first executable binary code and the second object code to a second executable binary code, identifying, using the processor, that the first virtual function table and the second virtual function table are identical and, using the processor, deleting the second virtual function table.

### BACKGROUND

Virtual function tables are mechanisms used in programming languages to support run-time method binding, which associates a value (a sequence of bits) with an identifier (often tokens or symbols). A virtual function table for an object may contain the addresses of all dynamically bound methods associated with the object. Method calls may be performed by retrieving the method's address from the object's virtual function table. In some programming languages, a virtual function table may be created when source code is converted into object code.

At times, duplicate virtual function tables may be created. For example, when source code contains more than one class in a hierarchy (e.g., the class “animal” has the subclasses “cat,” “dog,” and “horse”), then the virtual function table that is created for each member of the class in the hierarchy may be identical. When object files (also known as object codes or objects) are linked into an executable binary file, each corresponding virtual function table, even if it is a duplicate of another virtual function table, may be linked into the executable binary file.

### SUMMARY

One or more embodiments of the present invention relate to a method for duplicate virtual function table removal. The method includes identifying, using a processor of a computer, a first virtual function table formed when a first source code is compiled into a first object code. The method further includes using the processor, identifing a second virtual function table formed when a second source code is compiled into a second object code. The method further includes, independent of linking the first object code to a first executable binary code and the second object code to a second executable binary code, identifying, using the processor, that the first virtual function table and the second virtual function table are identical and, using the processor, deleting the second virtual function table.

One or more embodiments of the present invention relate to a system for duplicate virtual function table removal. The system includes a compiler configured to generate a first virtual function table within a first object code from a first source code and generate a second virtual function table within a second object code from a second source code. The system also includes an optimizer configured to identify that the first virtual function table and the second virtual function table are identical and delete the second virtual function table.

Other aspects of the invention will be apparent from the following description and the appended claims.

### BRIEF DESCRIPTION OF DRAWINGS

FIG. 1 shows a schematic diagram of a system in accordance with one or more embodiments of the invention.

FIG. 2 shows a flowchart of a method in accordance with one or more embodiments of the invention.

FIGS. 3A-6 show schematic diagrams of an example in accordance with one or more embodiments of the invention.

FIG. 7 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

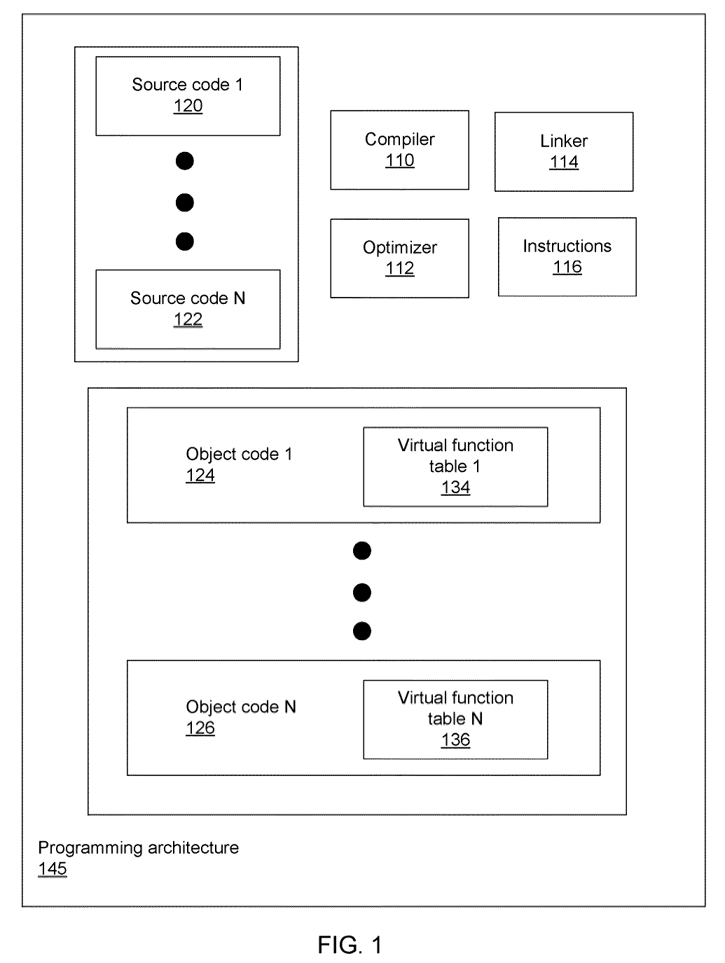

For purposes of clarification, a user may be a computer programmer, a customer, a client, another computer program, or any other entity capable of using and/or creating a computer program associated with the removal of duplicate virtual function tables. Also, as shown in FIG. 1, more than one source code (e.g., source code 1 (120), source code N (122)) may be stated as a first source code, a second source code, and so on. Similar configurations may apply to other components of the invention that occur in multiple instances, including but not limited to object codes and virtual function tables.

In general, embodiments of the invention provide a method and system for the removal of duplicate virtual function tables. More specifically, one or more embodiments of the invention provide a method and system for finding duplicate virtual function tables during a linking and removing the duplicate tables.

FIG. 1 shows a diagram of a system in accordance with one or more embodiments of the invention. The system is a programming architecture (145) that includes a compiler (110), an optimizer (112), a linker (114), instructions (116), a series of source codes (e.g., source code 1 (120), source code N (122)), and a series of object codes (e.g., object code 1 (124), object code N (126)). Each of the series of object codes (e.g., object code 1 (124), object code N (126)) includes a virtual function table (e.g., virtual function table 1 (134), virtual function table N (136)). Each of these components is described below.

The programming architecture (145) may be a standalone program, a subprogram, or a program that operates in conjunction with other programs. The system on which the programming architecture (145) operates may be a plug-in of another system, an internet-based system, a network, a system that resides on a standalone desktop computer, or some other suitable system. One of ordinary skill in the art will appreciate that embodiments of the invention are not limited to the configuration shown in FIG. 1.

In one or more embodiments of the invention, the programming architecture (145) includes a number of source codes (e.g., source code 1 (120), source code N (122)). Source codes (e.g., source code 1 (120), source code N (122)) may be a collection of statements and/or declarations written in a human-readable and/or object-oriented computer programming language. The source codes (e.g., source code 1 (120), source code N (122)) may be written in a complex programming language, including but not limited to D, Visual Basic®, Delphi®, C++, C#, Java®, and Perl®. (Visual Basic is a registered trademark of Mircosoft Corporation of Redmond, Wash.; Delphi is a registered trademark of Embarcadero Technologies, Inc., of San Francisco, Calif.; Java is a registered trademark of Sun Microsystems of Santa Clara, Calif.; Perl is a registered trademark of The Perl Foundation of Ann Arbor, Mich.) Alternatively, the source codes (e.g., source code 1 (120), source code N (122)) may be written in a lower level programming language, including but not limited to machine code and assembly code. In one or more embodiments of the invention, the source codes (e.g., source code 1 (120), source code N (122)) enable the programmer to communicate with and instruct a computer. Each of the source codes (e.g., source code 1 (120), source code N (122)) may be a file or part of a file.

In one or more embodiments of the invention, the compiler (110) is configured to transform the source codes (e.g., source code 1 (120), source code N (122)) into object codes (e.g., object code 1 (124), object code N (126)). Each of the object codes (e.g., object code 1 (124), object code N (126)) may be written in a lower level programming language relative to the programming language in which its corresponding source code (e.g., source code 1 (120), source code N (122)) is written. Alternatively, each of the object codes (e.g., object code 1 (124), object code N (126)) may be written in a complex programming language relative to the programming language in which its corresponding source code (e.g., source code 1 (120), source code N (122)) is written. In one or more embodiments of the invention, the computer programming language in which the source codes (e.g., source code 1 (120), source code N (122)) are written is different than the computer programming language in which the object codes (e.g., object code 1 (124), object code N (126)) are written. The object codes (e.g., object code 1 (124), object code N (126)) may be in a binary format. Each of the object codes (e.g., object code 1 (124), object code N (126)) may be a file or part of a file.

In one of more embodiments of the invention, the compiler (110) is configured to transform the source codes (e.g., source code 1 (120), source code N (122)) into object codes (e.g., object code 1 (124), object code N (126)) to create an executable computer program. Each of the object codes (e.g., object code 1 (124), object code N (126)) may include a text section and a data section. In one or more embodiments of the invention, the text section of an object code (e.g., object code 1 (124), object code N (126)) contains executable instructions. Those skilled in the art will appreciate that the text section of an object code (e.g., object code 1 (124), object code N (126)) may also be known by other names, including but not limited to a code segment, a text segment, and text. The data section of an object code (e.g., object code 1 (124), object code N (126)) may include one or more global variables, such as virtual function tables (e.g., virtual function table 1 (134), virtual function table N (136)) (described below) that are determined by the user, by default, or by a suitable combination thereof

The compiler (110) may be a program or set of programs. The compiler (110) may be a decompiler if the source codes (e.g., source code 1 (120), source code N (122)) are written in a lower level language and the object codes (e.g., object code 1 (124), object code N (126)) are written in a complex programming language. In one or more embodiments of the invention, each time that the compiler (110) transforms the source codes (e.g., source code 1 (120), source code N (122)) into object codes (e.g., object code 1 (124), object code N (126)), the compiler (110) also creates a corresponding virtual function table (e.g., virtual function table 1 (134), virtual function table N (136)). For a source code (e.g., source code 1 (120), source code N (122)) with multiple objects, the compiler (110) may generate a single virtual function table (e.g., virtual function table 1 (134), virtual function table N (136)) for all objects or one virtual function table (e.g., virtual function table 1 (134), virtual function table N (136)) for each object. In one or more embodiments of the invention, each virtual function table (e.g., virtual function table 1 (134), virtual function table N (136)) is embedded into the data section of the corresponding object code (e.g., object code 1 (124), object code N (126)).

The virtual function tables (e.g., virtual function table 1 (134), virtual function table N (136)) may be used by the compiler (110) to support run-time method binding. In one or more embodiments of the invention, the virtual function tables (e.g., virtual function table 1 (134), virtual function table N (136)) contain each address of a dynamically bound method within the object code (e.g., object code 1 (124), object code N (126)).

In one or more embodiments of the invention, the source codes (e.g., source code 1 (120), source code N (122)), the object codes (e.g., object code 1 (124), object code N (126)), and the virtual function tables (e.g., virtual function table 1 (134), virtual function table N (136)) may be located in the same location. Alternatively, the source codes (e.g., source code 1 (120), source code N (122)), the object codes (e.g., object code 1 (124), object code N (126)), and the virtual function tables (e.g., virtual function table 1 (134), virtual function table N (136)) may be located in different locations. A location may be defined as a computer, cache memory, a file, or some other suitable storage location.

In one or more embodiments of the invention, the linker (114) is configured to combine or link one or more object codes (e.g., object code 1 (124), object code N (126)) into a single executable program code. The linker (114) may be a computer program. The linker (114) may be configured to combine or link object codes (e.g., object code 1 (124), object code N (126)) that were generated by the compiler (110). Those skilled in the art will appreciate that the linker (114) may also be known by other names, including but not limited to a link editor, a loader, and a linkage editor.

In one or more embodiments of the invention, the optimizer (112) is configured to optimize object files (e.g., object code 1 (124), object code N (126)). Specifically, the optimizer (112) may be configured to identify and eliminate duplicate object codes (e.g., object code 1 (124), object code N (126)) before the linker (114) creates the single executable computer program. The optimizer (112) may perform one or more optimizations to identify and eliminate duplicate object codes (e.g., object code 1 (124), object code N (126)), including but not limited to analyzing the naming schemes of the virtual function tables (e.g., virtual function table 1 (134), virtual function table N (136)), analyzing certain characteristics (e.g., size, contents, symbols referenced) of the virtual function tables (e.g., virtual function table 1 (134), virtual function table N (136)), and distinguishing similar patterns in data sections of the virtual function tables (e.g., virtual function table 1 (134), virtual function table N (136)). The optimizer (112) may also read in all object codes (e.g., object code 1 (124), object code N (126)) to identify tile virtual function table (e.g., virtual function table 1 (134), virtual function table N (136)) in each corresponding object code (e.g., object code 1 (124), object code N (126)). In one or more embodiments of the invention, the optimizer (112) may have access to every virtual function table (e.g., virtual function table 1 (134), virtual function table N (136)) associated with a computer program.

In one or more embodiments of the invention, the instructions (116) are configured to coordinate the components of the programming architecture (145) in removing duplicate virtual function tables. Specifically, the instructions (116) may be configured to select the computer programming language for the source codes (e.g., source code 1 (120), source code N (122)) and for the object codes (e.g., object code 1 (124), object code N (126)). The instructions (116) may be configured to interpret and translate each of the source codes (e.g., source code 1 (120), source code N (122)) in the computer programming language of the source codes (e.g., source code 1 (120), source code N (122)) into the computer programming language of the object codes (e.g., object code 1 (124), object code N (126)) to create the object codes (e.g., object code 1 (124), object code N (126)). The instructions (116) may be configured to direct the timing and scope of operation of the compiler (110), the optimizer (112), and the linker (114). For example, the instructions (116) may initiate the linker (114) to instantaneously link the first one hundred object codes (e.g., object code 1 (124), object code N (126)) in the programming architecture (145). In one or more embodiments of the invention, the instructions (116) are set or modified by the user.

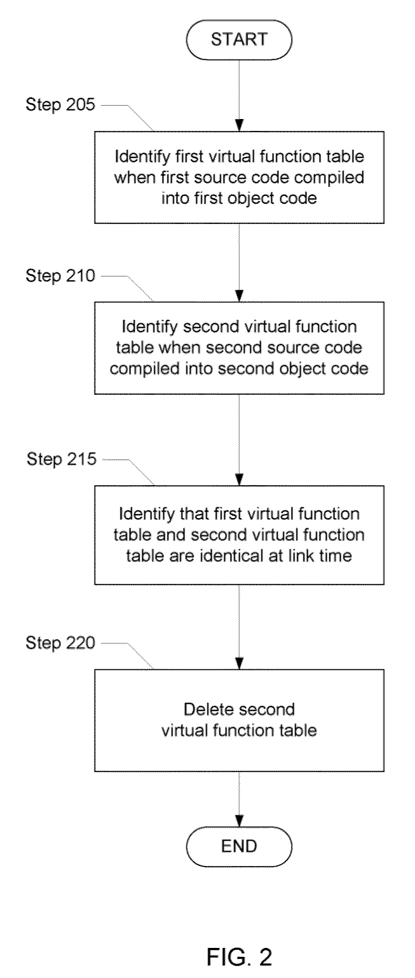

FIG. 2 shows a flowchart of a method for duplicate virtual function table removal in accordance with one or more embodiments of the invention. While the various steps in this flowchart are presented and described sequentially, one of ordinary skill will appreciate that some or all of the steps may be executed in a different order, may be combined or omitted, and may be executed in parallel. Further, in one or more of the embodiments of the invention, one or more of the steps described below may be omitted, repeated, and/or performed in a different order. In addition, a person of ordinary skill in the art will appreciate that additional steps, omitted in FIG. 2, may be included in performing this method for compressing data.

Referring to FIG. 2, in Step 205, a first virtual function table is identified when a first source code is compiled into a first object code. The first source code may be compiled into the first object code by a compiler. In one or more embodiments of the invention, compiling the first source code into the first object code includes creating and/or identifying the first virtual function table. The first virtual function table may located in a data section of the first object code. In one or more embodiments of the invention, an object of the first source code is part of a hierarchy that includes more than one class. For example, the first source code may include the class “orange,” which is a subclass of the superclass “fruit.”

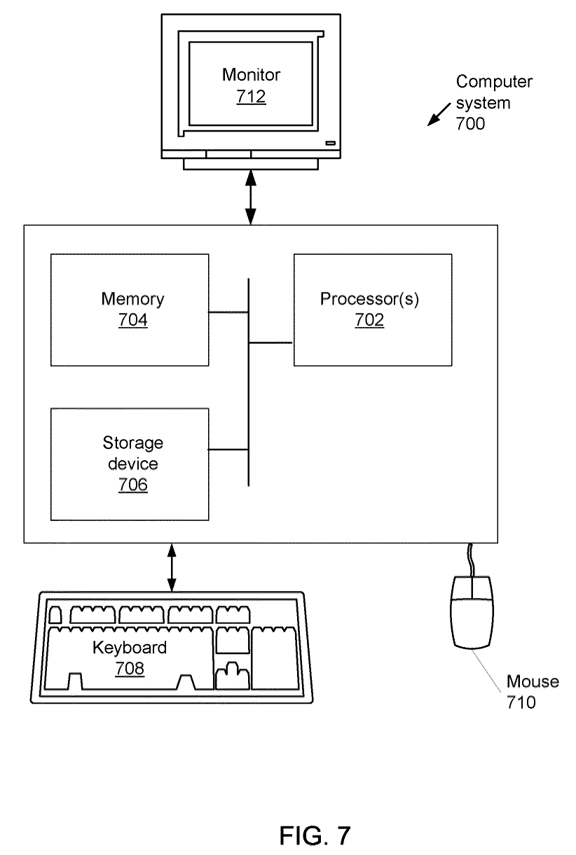

Object code (or, simply, an object) may be a sequence of computer instructions in a programming format. In a computer language where each object is created from a class, an object is called an instance of that class. Each object has a virtual function table associated with the class, and two objects with the same class have a duplication of at least a portion of the virtual function table for each object. Creating an instance of a class is sometimes referred to as instantiating the class. In other words, the virtual function table that is created for each member of the class in the hierarchy, or the portion(s) of the single virtual function table associated with each member of the class in the hierarchy, is identical. In one or more embodiments of the invention, a computer, as described with respect to FIG. 7 below, is used to identify the first virtual function table.

In Step 210, a second virtual function table is identified when a second source code is compiled into a second object code. The second source code may be compiled into the second object code by the compiler. In one or more embodiments of the invention, compiling the second source code into the second object code includes creating and/or identifying the second virtual function table. The second virtual function table may located in a data section of the second object code. In one or more embodiments of the invention, a computer, as described with respect to FIG. 7 below, is used to identify the second virtual function table. Those skilled in the art will appreciate that steps 205 and 210 may be repeated as many times as needed to accommodate all of the source code in a computer program.

In Step 215, the first virtual function table and the second virtual function table are identified as being identical at link time. In one or more embodiments of the invention, only specific portions of a virtual function table are considered when identifying that the first virtual function table and the second virtual function table are identical. Such specific portions of a virtual function table may include, but are not limited to, a naming scheme in a symbol table, characteristics of the virtual function table (e.g., size of the virtual function table, contents of the virtual function table, symbols that the virtual function table reference), and patterns in the rest of the data section. Such specific portions of the virtual function table may be determined by default, by a user, or by a suitable combination thereof. Alternatively, all portions of a virtual function table may be considered when identifying that the first virtual function table and the second virtual function table are identical.

Continuing with Step 215, in one or more embodiments of the invention, the first virtual function table and the second virtual function table are identified as identical at a point in time when the first object code and the second object code are linked into an executable binary file. The first virtual function table and the second virtual function table may be identified as identical at a point in time preceding linking the first object code and the second object code. In one or more embodiments of the invention, the first virtual function table and the second virtual function table, or specific portions thereof, are similar in order to be identified as identical. Specifically, similarity between the first virtual function table and the second virtual function table may be based on user-defined criteria, default settings, or a suitable combination thereof. In one or more embodiments of the invention, a computer, as described with respect to FIG. 7 below, is used to identify the first virtual function table and the second virtual function table as identical.

In Step 220, the second virtual function table is deleted. In one or more embodiments of the invention, a computer, as described with respect to FIG. 7 below, is used to delete the second virtual function table.

### EXAMPLE

The following scenario describes a method to remove duplicate virtual function tables in accordance with one or more embodiments described above. In this example, a hierarchy is established where a parent class is Shape, and the classes Square and Circle are subclasses that are derived from parent class Shape.

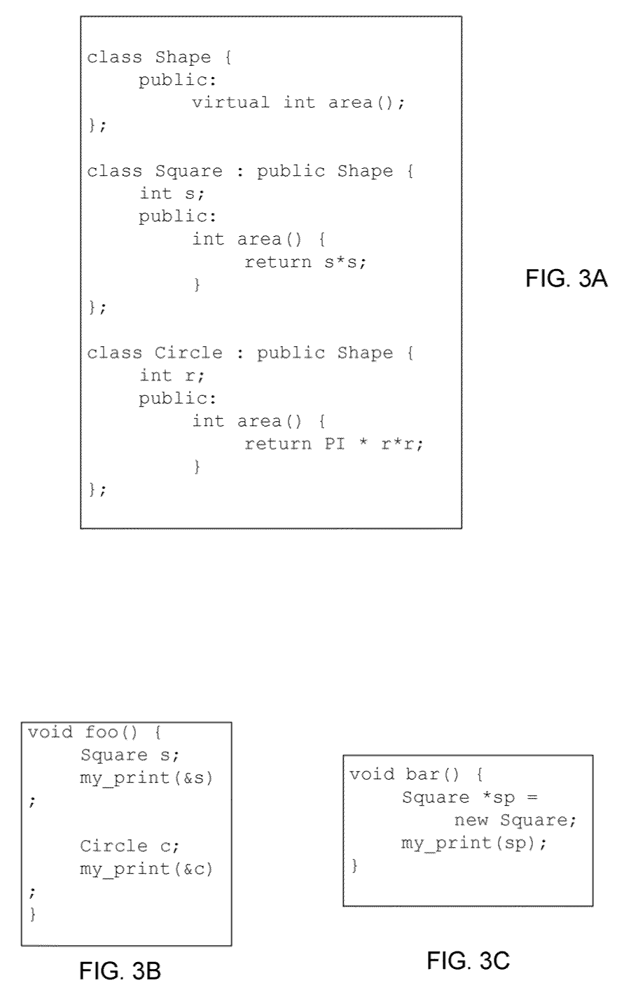

FIG. 3A shows a header file, written in C++, for parent class Shape, defined in terms of an area. In addition, the header file also defines class Square and class Circle in terms of area and as belonging to parent class Shape. FIG. 3B shows source code, associated with the header file in FIG. 3A, instantiating class Square and class Circle. Likewise, FIG. 3C shows source code, also associated with the header file in FIG. 3A, instantiating only class Square.

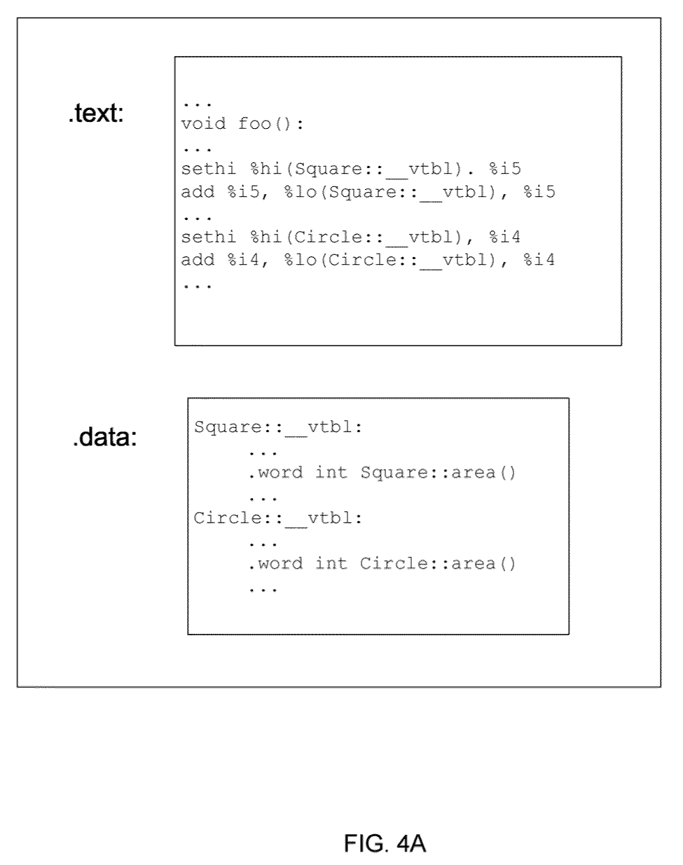

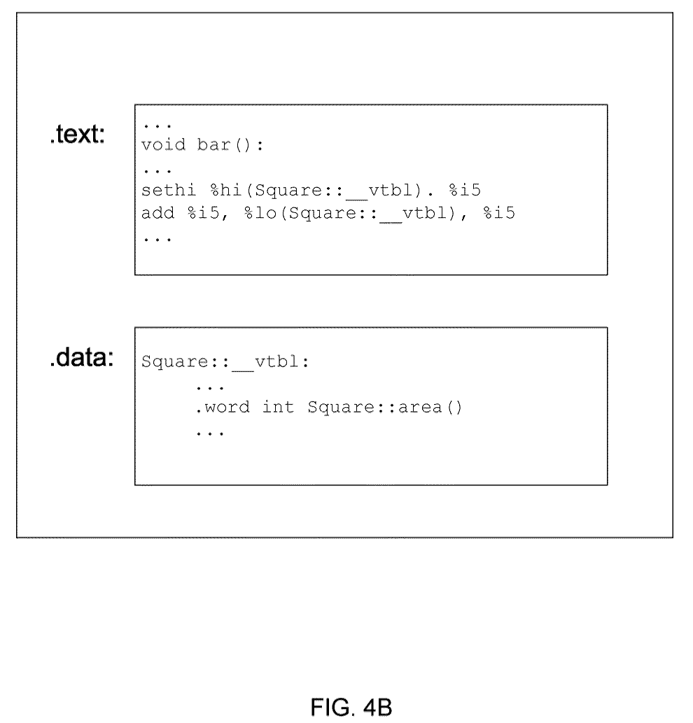

FIGS. 4A and 4B shows object code generated by a compiler from the source code shown in FIGS. 3B and 3C, respectively. Each object code shown in FIGS. 4A and 4B includes a text file and a data file. The text file may also be referred to as a text section, and the data file may also be referred to as a data section. The text file is the object code itself, while the data file is the virtual function table associated with the object code. FIG. 4A shows two virtual function tables, which includes a virtual function table for class Square (“Square::_vtbl”) and a virtual function table for class Circle (“Circle::_vtbl”), because objects of both types were instantiated, as shown in FIG. 3B. FIG. 4B shows only a single virtual function table, which includes only a virtual function table for class Square, because only an object of class Square was instantiated, as shown in FIG. 3C. The virtual function table in FIG. 4B (“Square::_vtbl”) is an exact duplicate of the Square virtual function table in FIG. 4A.

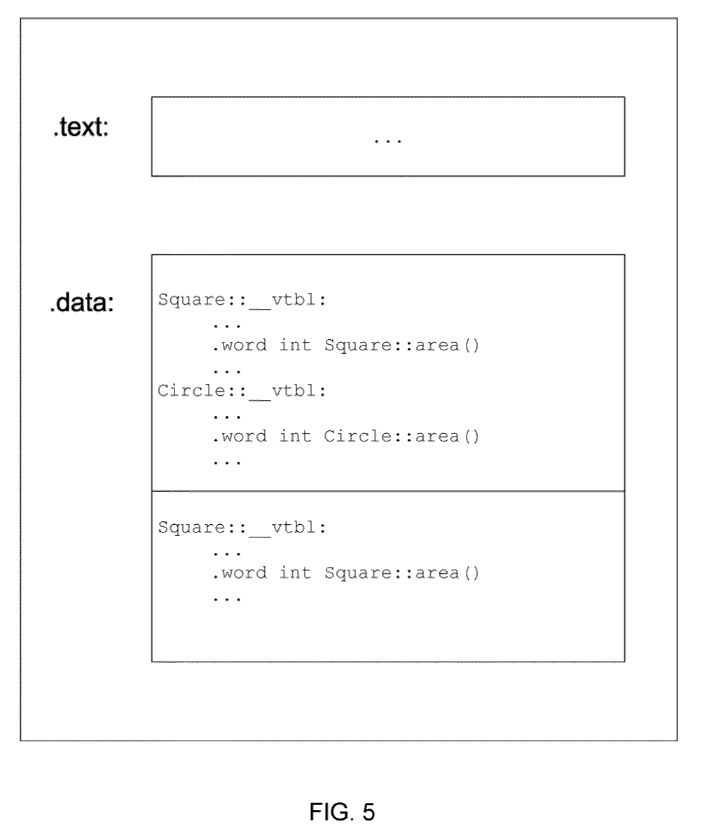

FIG. 5 shows an executable binary file created during a linking process without optimization. The linking may be preformed by a linker. During the linking process, object codes are combined. In this example, the object codes shown in FIGS. 4A and 4B are combined during the linking process to produce the resulting executable binary file. Without an optimizer to eliminate duplicate virtual function tables, the executable binary file includes all duplicate virtual function tables and inefficiently becomes larger than necessary. For simplicity, only the combination of the data sections (not the text sections) from the object codes are shown in FIG. 5.

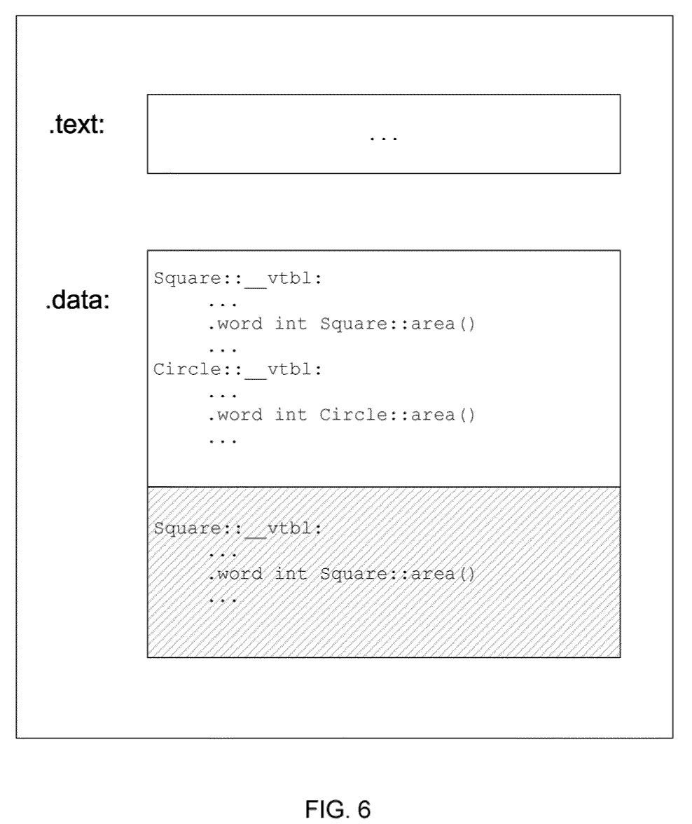

FIG. 6 shows the executable binary file of FIG. 5 after optimization. As shown, an optimizer identifies and deletes the duplicate virtual function table. (In this example, the deleted duplicate virtual function table is shown in hatching for clarity, however, those skilled in the art will appreciate that, once deleted, no duplicate virtual function table will exist.). In this example, the duplicate virtual function table associated with the class Square from FIG. 4B was an exact duplication of the portion of the virtual function table from FIG. 4A associated with the class Square.

As mentioned previously, a virtual function table may not need to be an exact match with another virtual function table to be considered a duplicate. For example, if the virtual function table in FIG. 4B read “.word int Square::circumference( )” instead of “.word int Square::area( )”, this virtual function table may still have been may have been identified as a duplicate and deleted, even though it was similar and not identical to the portion of the virtual function table shown in FIG. 4A. For example, parent class Shape may have been defined in terms of both area and circumference. As another example, the user may have created a setting to determine that any class Square, whether defined in terms of area, circumference, or some other characteristic, is considered a duplicate. As a further example, the user may have created a setting to determine that any member of superclass Shape, whether defined in terms of area, circumference, or some other characteristic, is considered a duplicate.

The optimizer may operate concurrently with the linking process, as in this example. The optimizer may also operate prior to the formation of the executable binary file. The operation of the optimizer may be triggered by a linking process. The operation of the optimizer may also be triggered by some other event or a passage of time, whether defined by the user or set by default. As with FIG. 5, for simplicity, only the combination of the data files (not the text files) from the object codes are shown in FIG. 6.

In one or more embodiments of the invention, implementation of removing duplicate virtual function tables reduces the amount of storage space needed on a storage medium and/or in cache memory. In addition, since the compiler and/or linker may have a limited queue, removing duplicate virtual function tables may create more room in the queue of the compiler and/or linker. Further, removing duplicate virtual function tables prior to execution of the executable binary may reduce the execution time.

Embodiments of the invention may be implemented on virtually any type of computer regardless of the platform being used. For example, as shown in FIG. 7, a computer system (700) includes one or more processor(s) (702), associated memory (704) (e.g., random access memory (RAM), cache memory, flash memory, etc.), a storage device (706) (e.g., a hard disk, an optical drive such as a compact disk drive or digital video disk (DVD) drive, a flash memory stick, etc.), and numerous other elements and functionalities typical of today's computers (not shown). The computer (700) may also include input means, such as a keyboard (708), a mouse (710), or a microphone (not shown). Further, the computer (700) may include output means, such as a monitor (712) (e.g., a liquid crystal display (LCD), a plasma display, or cathode ray tube (CRT) monitor). The computer system (700) may be connected to a network (714) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms, now known or later developed. Generally speaking, the computer system (700) includes at least the minimal processing, input, and/or output means necessary to practice embodiments of the invention.

Further, those skilled in the art will appreciate that one or more elements of the aforementioned computer system (700) may be located at a remote location and connected to the other elements over a network. Further, embodiments of the invention may be implemented on a distributed system having a plurality of nodes, where each portion of the invention (e.g., data compression module, data decompression module) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, or any other physical computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for duplicate virtual function table removal comprising:
identifying, using a processor of a computer, a first virtual function table formed when a first source code is compiled into a first object code;
using the processor, identifying a second virtual function table formed when a second source code is compiled into a second object code; and
independent of linking the first object code to a first executable binary code and the second object code to a second executable binary code:
identifying, using the processor, that the first virtual function table and the second virtual function table are identical; and
using the processor, deleting the second virtual function table.

2. The method of claim 1, further comprising:
generating a final executable binary code by linking the first executable binary code and the second executable binary code.

3. The method of claim 2, wherein identifying that the first virtual function table and the second virtual function table are identical is performed when generating the final executable binary code.

4. The method of claim 3, wherein the second virtual function table is deleted when generating the final executable binary code.

5. The method of claim 1, wherein identifying that the first virtual function table and the second virtual function table are identical comprises comparing at least one of a group consisting of a naming scheme in a symbol table, characteristics of the first and second virtual function table, and patterns in the rest of the data section of the first and second virtual function table.

6. The method of claim 5, wherein characteristics of the first and second virtual function tables comprise at least one of a group consisting of a size, a content, and a symbol of reference.

7. The method of claim 1, wherein identifying that the first virtual function table and the second virtual function table are identical comprises identifying a portion of the first virtual function table that is identical to a portion of the second virtual function table.

8. The method of claim 7, wherein the portion of the second virtual function table is deleted.

9. The method of claim 1, wherein the second virtual function table is deleted based on being similar to the first virtual function table.

10. The method of claim 9, wherein determining that the first virtual function table and the second virtual function table are similar is based on criteria established by a user.

11. The method of claim 10, wherein the second virtual function table is deleted based on the criteria established by the user.

12. The method of claim 1, wherein a language used to program data associated with the first virtual function table is an object-oriented programming language.

13. The method of claim 12, wherein the object-oriented programming language is one of a group consisting of C++, D, C#, Visual Basic, and Delphi.

14. A system for duplicate virtual function table removal comprising:
a compiler configured to:
generate a first virtual function table within a first object code from a first source code; and
generate a second virtual function table within a second object code from a second source code; and
an optimizer configured to:
identify that the first virtual function table and the second virtual function table are identical; and
delete the second virtual function table.

15. The system of claim 14, further comprising:
a linker configured to link the first object code associated with the first virtual function table to a first executable binary code and the second object code associated with the second virtual function table to a second executable binary code.

16. The system of claim 15, wherein the linker is further configured to:
generate a final executable binary code by linking the first executable binary code and the second executable binary code.

17. The system of claim 16, wherein the optimizer is further configured to operate when the linker operates.

18. The system of claim 16 further comprising:
instructions configured to coordinate the compiler, the optimizer, and the linker.

19. The system of claim 18, wherein the instructions are able to be modified by a user.

20. The system of claim 15, wherein the first virtual function table and the second virtual function table are in different locations.
